(19) United States
(12) Patent Application Publication
(10) Pub. No.: US 2017/0015439 A1
(43) Pub. Date: Jan. 19, 2017

(54) Portable Runway

(71) Applicants: David Dor-El, Los Angeles, CA (US); Itzhak Shalev, Bet Gamliel (IL)

(72) Inventors: David Dor-El, Los Angeles, CA (US); Itzhak Shalev, Bet Gamliel (IL)

(21) Appl. No.: 14/800,887

(22) Filed: Jul. 16, 2015

(51) Int. Cl. B64F 1/04; E01C 11/00; E01C 21/00; E01C 19/02; E01C 19/08; E01C 23/14; E01C 9/08; E01C 19/48

(52) U.S. Cl. CPC B64F 1/04; E01C 9/086; E01C 11/005; E01C 19/48; E01C 19/02; E01C 19/08; E01C 23/14; E01C 21/00; B29C 71/02

(57) ABSTRACT

A portable runway includes a sheet of thermoplastic composite materials that is rolled out to form the runway track and then heat cured in place to form a rigid. Suitable composite materials are glass, carbon or aramid fibers are co-mingled with thermoplastic fibers such as polyamides, polyolefins, polyesters, polyacrylates and polyimides so that the pliable co-mingled materials is in either fiber bundle (“tow”), yarn, braid, fabric or non-woven forms are layed down on the pregraded earth by unrolling, unstacking, unfolding, dispesing or spraying. Once in place the composite materials are consolidated and hardened by application of heat. The width of the surface of said portable runway may range from 1 meter to 25 meters. Anchoring pegs may be inserted along the edges of said portable runway prior to curing with the thickness of the surface ranging from 1 cm to 50 cm and the areal weight of the surface ranging from 50 grams per square meter (GSM) to 2,000 GSM.

### BACKGROUND OF THE INVENTION

### Field of the Invention

The invention relates to a portable runway that is based on thermoplastic composite materials and more particularly to a portable runway that is rolled out to form the runway track and is then heat cured in place to form the rigid surface that is required.

### Description of the Prior Art

Military, unmanned and emergency civilian aircraft may have the need to land and take off in terrain that is not suitable for construction of a hard surface runway. In addition, a permanent hard surface runway is vulnerable to attack and destruction by adversary forces or by natural calamity. The portable runway is required to be able to withstand the loads and stresses associated with aircraft impact, acceleration and deceleration. The portable runway must be durable to weather, solar irradiation and soil movement and should be simple to repair and maintain. The portable runway must perform well in all the above stated areas. Additionally it must be easy to transport and be readily deployable.

The US Army Corp developed steel landing mats as an alternative surfacing for portable airfield runways just prior to World War II. Though rigid enough to bridge over small surface inequalities on the ground, the landing mats were best used on stabilized sub-grade. These original landing mats were commonly known as, marsden matting, Marston mats, or PSP (Pierced Steel Plank). The PSP or Marston mats are 16″ by 10′ and are approximately 0.140″ thick. This runway matting is made of hardened steel for strength and to resist corrosion. These portable runways mats have a punched hole-pattern consisting of three rows of 29 holes, resulting in 87 holes per mat. They also have two corrugated U shaped channels formed between the rows of holes. The Marston mat was utilized for military aircraft portable runways, beach landings, temporary roads, airfield taxing routes and storage pads for heavy equipment and supplies. The Marston mat was used extensively during World War II by front line construction personnel to build portable runways and other readily usable surfaces over all kinds of terrain in the Pacific Theater of Operations. In various countries in the Pacific Theater, particularly New Guinea, matting remains in use as fencing or road barriers, in some cases stretching for miles.

Even though the Marston mat or PSP became the runway matting deployed nearly universally, the Air Corps seriously considered using aluminum. This material offered the opportunity of reducing the mats weight so that smaller planes could carry it into areas inaccessible to heavier aircraft. The design of the lightweight aluminum alloy planks mirrored the standard PSP. Since its service life was only half as long, the aluminum-landing mat never replaced the steel during the World War as portable runways.

A solid corrugated landing mat was developed and utilized as portable runways and used extensively during the Vietnam War as portable runways for aircraft. With the use of jet powered aircraft replacing propeller driven aircraft, problems with foreign object debris (FOD) arose. Jet engines safety and performance were degraded. For this reason, the M8A1 mat was designed. The M8A1 mats were 12′ by 22″, constructed from a solid sheet of steel and contained no holes. They were reinforced by 4 corrugated channels the length of the mat. These mats were eventually replaced with the AM-2 aluminum mat as portable runways. Because of the high resale value of the aluminum mats, many still use the steel mats for large projects, such as runway matting.

The JR mat is the European equivalent of the M8A1. Measuring 10′ by 18″, it is slightly smaller, but still has the performance of the M8A1. The JR mat is a solid steel mat with 3 corrugations running the length of the mat. The JR mat is made of a hardened steel to give them strength and resist corrosion. To benefit traction, each mat is embossed. Because of their size, the JR mats make great portable runways. These Portable Runways Helped Win the War in the Pacific. Low-tech and still used today, “Marston Mats” were among the most important inventions of World War II. Airfields in Alaska's Aleutian chain started getting steel mat runways in 1942. Marston was better than mud, but a hard landing could bounce a small fighter 30 feet, and heavy bombers made the mat ride up in waves.

In 1941, a month before Pearl Harbor, General “Hap” Arnold of the U.S. Army Air Corps visited Camp Mackall in rural North Carolina, and stood in a soft pitch of pine tar at the edge of its airfield. The general was there to watch tens of thousands of paratroopers take flight in a massive war game called the Carolina Maneuvers. Arnold called it “the year's greatest achievement in aviation warfare,” but he wasn't referring to the exercise, or the half-million troops, or even the aircraft, but rather the “Marston Strip” on which they landed. Marston Matting got its nickname from the nearby town of Marston, N.C., where it was produced. The concept had come from the Carnegie Illinois Steel Company, who under an Army contract designed temporary flight strips to run alongside U.S. highways. The mats were a simple way for crews to quickly put down a runway on any ground, paved or unpaved, where there was none, which came in handy in the remote islands of the Pacific.

Its official Air Corps name was PSP for perforated (or pierced) steel planking. “Marston,” or the incorrect but widely used “Marsden,” was tested at Langley Field in Virginia and perfected during the Carolina Maneuvers. Marston Mat had its first large test in November of 1941 for the Carolina Maneuvers, a massive war game pitting hundreds of thousands of troops against rival military camps in rural towns. The steel mat came in rolls of interlocking 10-foot sections, which were ringed with hooks and slots for easy assembly by strong men using sledgehammers. A completed airstrip ran 3,000 feet long and 150 feet wide. Each mat was pierced with 87 holes to allow drainage, which also reduced its weight to 66 pounds per section. A later aluminum version came in at just 32 pounds and could be laid down at a trot. Marston was often laid over the local vegetation, which varied depending on the location from loose straw to palm fronds. The sandwich of steel and vegetation absorbed moisture and cut the dust kicked up by heavy aircraft. The first PSP airstrip took a pokey 11 days to install. By the end of World War II an airfield could be carried across the Pacific within a single cargo hold of a Liberty ship, and could be ready for aircraft to land 72 hours after unloading.

At first the U.S. had Marston to itself, but eventually the invention was shared with its Allies, including Russia under the Lend-Lease program. Two million tons of temporary runways were produced in WWII to bring American airfields to each island captured from the Japanese. Marston has been used in every war since. Matting reclaimed from the jungle also has found new uses in guardrails or footbridges, while in the U.S., government surplus is sold for use in cattle chutes and warehouse floors. Military, unmanned and emergency civilian aircraft may have the need to land and take off in terrain that is not suitable for construction of a hard surface runway. In addition, a permanent hard surface runway is vulnerable to attack and destruction by adversary forces or by natural calamity. Aircraft runways are required to be able to withstand the loads and stresses associated with aircraft impact, acceleration and deceleration. In addition, runways must be durable to weather, solar irradiation and soil movement and should simple to repair and maintain.

U.S. Patent Publication No. 2014/0010619 teaches in an airfield with a short bi-directional runway and a long bi-directional runway intersecting with each other perpendicularly a system for storing and launching a plurality of airplanes includes a plurality of platforms, a plurality of rectangular cages and a frame. Onto each platform one airplane may be placed. Each cage has an opening into which one platform and one airplane are inserted through the opening. The frame has a plurality of slots and is disposed in ground beneath the airfield. One rectangular cage may be inserted into one of the slots. An elevator is disposed adjacent to the frame and has a bottom platform and an opening that may be aligned with the opening of one of the slots.

U.S. Pat. No. 7,056,576 teaches a shear-resistant Z-axis fiber-reinforced composite laminate structure which includes a core material, an upper laminate, a lower laminate and a plurality of contiguous cured resin Z-axis fiber bundles which are disposed in the core material between the upper laminate and the lower laminate to form high moment-of-inertia solid composite structural elements in the core material.

U.S. Pat. No. 6,645,333 and U.S. Pat. No. 6,676,785 teach methods for forming a Z-axis fiber-reinforced composite laminate structure.

U.S. Pat. No. 6,645,333 and U.S. Pat. No. 6,676,785 teach Z-axis fiber bundles which will necessarily be longer. The length (L-term) of the Z-axis fiber bundles in equation 1 becomes greater, and because deflection is directly proportional to the cube of the length, the deflection becomes greater. The shear modulus decreases as the sandwich thickness increases, making the shear deflections excessive and the fiber composite structure inadequate for larger sandwich thickness applications requiring flexural stiffness and shear stiffness.

U.S. Pat. No. 7,162,838 teaches a constructional panel which has a generally rectangular central section and two opposed end sections. Each panel has an isosceles trapezoid part, its short edge conjoined to an edge of the central section and its long edge conjoined to a rectangular part, there being oblique edges extending between the long and short edges. The panel is thus bound by one pair of opposed edges of the central section, the oblique edges of the two end sections, one pair of opposed edges of the rectangular part and a further edge of the rectangular part opposed to that edge conjoined to the trapezoid part. The panel edges are configured for connection to the corresponding edges of like panels to build up an area of paneling. Projecting tabs from some edges are received in corresponding receptors on opposed edges and having lock arrangements, whereby the inter-engaged panels may be locked together. The constructional panel may be built up into a generally planar array of individual like panels, interconnected by their adjacent edges. The method of builds up a substantially planar array of a plurality of individual panels.

Patent Publication No. WO 97/18353 teaches a generally rectangular panel provided with interconnecting mechanisms on its four edges, to permit the connection of the panel to four other panels arranged one alongside each of the four edges of the first panel. In this way, a relatively large-scale essentially planar structure may be built, suitable for use as temporary decking for soft ground, hard standing for aircraft, a temporary track-way over ground, or even suitable for use as a temporary runway for aircraft, amongst many other possible uses. Equally the panels may be relatively small such that the array of interconnected panels may be used to floor a relatively small area, such as of a marquee erected on grass. Other examples of panels suitable for interconnection to form an extensive array may also be found in U.S. Pat. No. 3,500,606, U.S. Pat. No. 4,373,306 and International Patent Specification No. WO 91/13208. In each patent the described panel is of a rectangular shape and is interconnected to four adjacent panels by an arrangement provided on the respective edges of the panels. A disadvantage of the arrays of panels described in all of the above documents is that the panels are disposed in a rectangular grid arrangement, with straight lines between the rows and columns of panels. Almost inevitably, the interconnections between the panels are weaker than the panels themselves and so there are lines of weakness extending linearly both transversely and along the length of the array, at regularly spaced intervals. The laminate panel described in WO 97/18353 has the advantage that a number of the connected panels may be rolled up for transport or storage, but the long straight lines of interconnection do still reduce the rigidity and strength of the array of connected panels.

U.S. Pat. No. 7,217,453 teaches a method which forms a protruded and clinched Z-axis fiber which is a reinforced composite laminate structure. The upper and lower skins and the core are pulled automatically through tooling where the skin material is wetted-out with resin and the entire composite laminate is preformed in nearly its final thickness. The preformed composite laminate continues to be pulled into an automatic 3-dimensional Z-axis fiber deposition machine that deposits “groupings of fiber filaments” at multiple locations normal to the plane of the composite laminate structure and cuts each individual grouping such that an extension of each “grouping of fiber filaments” remains above the upper skin and below the lower skin. The preformed composite laminate then continues to be pulled into a secondary wet-out station. Next the preformed composite laminate travels into a pultrusion die where the extended “groupings of fiber filaments” are all bent over above the top skin and below the bottom skin producing a superior clinched Z-axis fiber reinforcement as the composite laminate continues to be pulled, catalyzed, and cured at the back section of the protrusion die. The composite laminate continues to be pulled by grippers that then feed it into a gantry CNC machine that is synchronous with the pull speed of the grippers and where computerized machining, drilling, and cutting operations take place. This entire method is accomplished automatically without the need for human operators. U.S. Pat. No. 5,935,680, U.S. Pat. No. 5,741,574 and U.S. Pat. No. 5,624,622 teach Z-directional reinforcements that are deposited in foam by an initial process and then secondarily placed between plies of fiber fabric and through heat and pressure, the foam crushes or partially crushes forcing the reinforcements into the skin. Practically, these reinforcements are pins or rods and require a certain stiffness to be forced into the skin or face layers. Although “tow members” are the Z-directional reinforcement, practically, these are cured tow members, or partially cured tow members that have stiffness. According to U.S. Pat. No. 5,624,622 compressing the foam core will “drive” the tow members into the face sheets. This cannot be possible unless the Z-directional or 3-D reinforcements are cured composite or metallic pins. A standard roll of fiberglass roving from Owens-Corning, typically comes in various yields (of yards per pound weight) and a yield of 113 would contain on a roll or doft 40 lbs. of 113 yield rovings. In the uncured state, these rovings are multiple filaments of glass fiber, each with a diameter of less than 0.0005 inches. The roving, uncured as it comes from Owens Corning, is sometimes called a “tow”, contains hundreds of these extremely small diameter filaments. These hundreds of filaments shall be referred to as a “grouping of fiber filaments.” These groupings of fiber filaments can sometimes be referred to, by those skilled in the art, as tows. It is impossible to drive a virgin glass fiber tow, or grouping of fiber filaments, as it is shipped from a glass manufacturer such as Owens Corning, through a face sheet. The grouping of fiber filaments will bend and kink and not be driven from the foam carrier into the skin or face sheets 0. The “tow” must be a rigid pin or rod in order for the process to work as described and allows easily for the deposition of these groupings of fiber filaments, completely through the skin-core-skin laminate structure, a new improvement in this field of 3-D reinforced laminate structures.

According to U.S. Pat. No. 4,808,461 the material of the reinforcing elements has sufficient rigidity to penetrate the composite structure without buckling and may be an elemental material such as aluminum, boron, graphite, titanium, or tungsten. This depends upon the core being a “thermally decomposable material”. Other U.S. patents that are included herein by reference are: U.S. Pat. No. 5,186,776, U.S. Pat. No. 5,667,859, U.S. Pat. No. 5,827,383, U.S. Pat. No. 5,789,061, U.S. Pat. No. 5,589,051 none of which indicate that the referenced processes can be automatic and synchronous with protrusion, nor do they state that the processes could be synchronous and in-line with protrusion.

U.S. Pat. No. 5,589,243 and U.S. Pat. No. 5,834,082 teaches a process to make a combination of foam and uncured glass fabric core that is later molded. The glass fiber in the core never penetrates the skins of the laminate and instead fillets are suggested at the interface of the interior fiber fabric and the skins to create a larger resin fillet. This is a poor way to attempt to tie the core to the skins, as the fillet will be significantly weaker than if the interior fiber penetrated the skins. The only way to take preinstalled reinforcements in foam, and then later mold these to face sheets under pressure, and further have the interior fiber forced into the skins, is to have rigid reinforcements, such as rigid pins or rods or rigid sheets.

U.S. Pat. No. 5,186,776 teaches using ultrasound to insert a fiber through a solid laminate that is not a sandwich structure. This would only be possible with a thermoplastic composite that is already cured and certain weaknesses develop from re-melting a thermoplastic matrix after the first solidification. Ultrasound is not a requirement as new and improved means for depositing groups of fiber filaments are now used.

U.S. Pat. No. 5,869,165 teaches “barbed” 3-D reinforcements which helps and which has superior performance in that the 3-D groups of fiber filaments are extended beyond the skins on both sides of the composite laminate, such that a riveting, or clinching, of the ends of the filaments occurs when the ends of the filaments are entered into the pultrusion die and cured “on-the-fly.” The clinching provides improved pull-out performance, much in the same way as a metallic rivet in sheet metal, that is clinched or bent over on the ends, improves the “pull-out” of that rivet versus a pin or a bonded pin in sheet metal. This is different from the current state-of-the-art. Fiber through the core is either terminated at the skins, unable to penetrate the skins, or as pure rods penetrates part or all of the skin, but is not riveted or clinched. Many of the techniques referenced above will not work with cores that don't crush like foam and will not work with a core such as balsa wood, which will not crush and thus cannot “drive” cured rods or pins into a skin or face sheet. The difficult, transition from a composite laminate structure to an edge can easily be accommodated. A composite laminate structure can be protruded with clinched 3-D groupings of fiber filaments and at the same time the edges of the protruded composite laminate can consist of solid composite with the same type and quantity of 3-D grouping of fiber filaments penetrating the entire skin-central composite-skin interface. The skins can remain continuous and the interior foam can transition to solid composite laminate without interrupting the protrusion process.

U.S. Pat. No. 7,846,528 teaches a method which forms a protruded and clinched Z-axis fiber with a reinforced composite laminate structure. The upper and lower skins and the core are pulled automatically through tooling where the skin material is wetted-out with resin and the entire composite laminate is preformed in nearly its final thickness. The preformed composite laminate continues to be pulled into an automatic 3-dimensional Z-axis fiber deposition machine that deposits “groupings of fiber filaments” at multiple locations normal to the plane of the composite laminate structure and cuts each individual grouping such that an extension of each “grouping of fiber filaments” remains above the upper skin and below the lower skin. The preformed composite laminate then continues to be pulled into a secondary wet-out station. Next the preformed composite laminate travels into a pultrusion die where the extended “groupings of fiber filaments” are all bent over above the top skin and below the bottom skin producing a superior clinched Z-axis fiber reinforcement as the composite laminate continues to be pulled, catalyzed, and cured at the back section of the pultrusion die. The composite laminate continues to be pulled by grippers that then feed it into a gantry CNC machine that is synchronous with the pull speed of the grippers and where computerized machining, drilling, and cutting operations take place. This entire method is accomplished automatically without the need for human operators.

U.S. Pat. No. 7,785,693 teaches a composite laminate structure which includes a first skin; a second skin; a core between the first skin and the second skin, the core including adjacent core sections and a Z-Y partition separating the adjacent core sections; and a plurality of distinct groupings of Z-axis fibers that extend from the first skin to the second skin through the adjacent core sections and the Z-Y partition separating the adjacent core sections. The composite laminate structures is known as sandwich structures formed with outside skins of a polymer matrix composite and an internal core of either foam, end-grain balsa wood, or honeycomb, and more specifically to the field of these sandwich structures which additionally have some type of Z-axis fiber reinforcement through the composite laminate and normal to the plane of the polymer matrix composite skins.

The applicants hereby incorporate the above referenced patents and patent publications into their specification.

### SUMMARY OF THE INVENTION

The invention is a portable runway which is based on thermoplastic composite materials and which is rolled out to form the runway track and is then heat cured in place to form the rigid surface that is required. The portable runway includes a sheet of thermoplastic composite materials that is rolled out to form the runway track and then heat cured in place to form a rigid. Suitable composite materials are glass, carbon or aramid fibers are co-mingled with thermoplastic fibers such as polyamides, polyolefins, polyesters, polyacrylates and polyimides so that the pliable co-mingled materials is in either fiber bundle (“tow”), yarn, braid, fabric or non-woven forms are layed down on the pregraded earth by unrolling, unstacking, unfolding, dispesing or spraying. Once in place the composite materials are consolidated and hardened by application of heat. The width of the surface of said portable runway may range from 1 meter to 25 meters. Anchoring pegs may be inserted along the edges of said portable runway prior to curing with the thickness of the surface ranging from 1 cm to 50 cm and the areal weight of the surface ranging from 50 grams per square meter (GSM) to 2,000 GSM.

In the first aspect of the invention the portable runway is able to withstand the loads and stresses associated with aircraft impact, acceleration and deceleration.

In the second aspect of invention the portable runway must be durable to weather, solar irradiation and soil movement and should simple to repair and maintain.

In the third aspect of the invention the portable runway must perform well in all the above stated areas and must be easy to transport and be readily deployable.

Other aspects and many of the attendant advantages will be more readily appreciated as the same becomes better understood by reference to the following detailed description and considered in connection with the accompanying drawing in which like reference symbols designate like parts throughout the figures.

From the foregoing it can be seen that a methods for assessing cognitive function in a subject have been described.

Accordingly it is intended that the foregoing disclosure and showing made in the drawing shall be considered only as an illustration of the principle of the present invention.

### DESCRIPTION OF THE DRAWINGS

FIG. 1 is a perspective view of a portable runway which is based on thermoplastic composite materials and which is rolled out to form the runway track according to the present invention.

FIG. 2 is a photograph of a travelling heat applicator that uses convective, radiant or conductive heating.

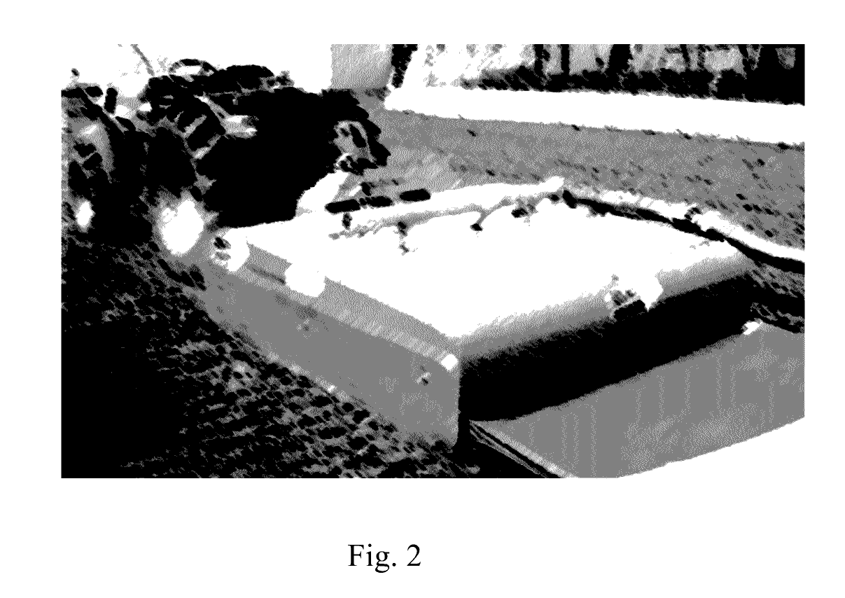

### DESCRIPTION OF THE PREFERRED EMBODIMENT

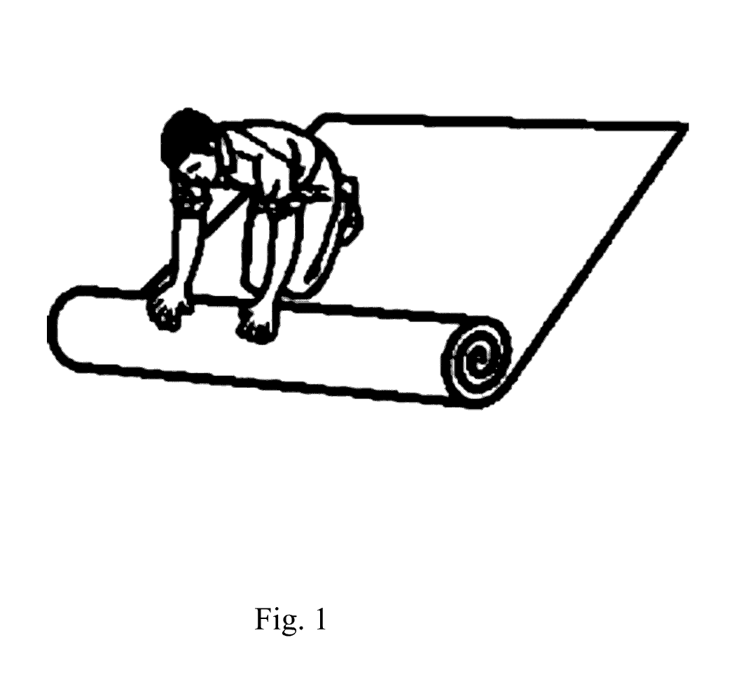

Referring to FIG. 1 before deployment a portable runway is a roll which is made out of thermoplastic composite materials and which is rolled out to form the runway track. The thermoplastic composite materials are then heat cured in place to form the rigid surface required. Curing may be accomplished by a mechanized heat application unit that travels along the runway path.

Suitable composite materials are glass, carbon or aramid fibers co-mingled with thermoplastic fibers such as polyamides, polyolefins, polyesters, polyacrylates and polyimides. The pliable co-mingled materials in either fiber bundle (“tow”), yarn, braid, fabric or non-woven forms are layed down on the pre-graded earth by unrolling, un-stacking, unfolding, dispensing or spraying. Once in place, the composite materials are consolidated and hardened (“cured”) by application of heat by a travelling heat applicator that uses convective, radiant or conductive heating. Solar energy may be also used as a heat source for curing. The width of the surface may range from 1 meter to 25 meters. Anchoring pegs may be inserted along the runway edges prior to curing. The thickness of the surface may range from 1 cm to 50 cm. The areal weight of the surface can range from 50 grams per square meter (GSM) to 2,000 GSM. Several layers of material may be stacked in order to obtain enhanced strength. The target terrain is leveled using suitable earth moving equipment and subsequently, the runway surface is deployed and anchored. Deployment can be done manually or using mechanized deployment equipment. Once usage had been completed, the portable runway can be refolded. Refolding the portable runway involves reheating it, then collapsing it and finally collecting it.

From the foregoing it can be seen that a portable runway that is based on thermoplastic composite materials and more particularly to a portable runway and that is rolled out to form the runway track and then heat cured in place to form the rigid surface that is required has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A portable runway comprising a sheet of thermoplastic composite materials which is rolled out to form the runway track and then heat cured in place to form a rigid wherein suitable composite materials are glass, carbon or aramid fibers are co-mingled with thermoplastic fibers such as polyamides, polyolefins, polyesters, polyacrylates and polyimides so that said pliable co-mingled materials is in either fiber bundle (“tow”), yarn, braid, fabric or non-woven forms are laid down on the pre-graded earth by unrolling, un-stacking, unfolding, dispensing or spraying whereby once in place said composite materials are consolidated and hardened by application of heat.

2. A portable runway according to claim 1 wherein the width of the surface of said portable runway may range from 1 meter to 25 meters and wherein anchoring pegs may be inserted along the edges of said portable runway prior to curing with the thickness of the surface ranging from 1 cm to 50 cm and the areal weight of the surface ranging from 50 grams per square meter (GSM) to 2,000 GSM.

3. A portable runway according to claim 2 wherein several layers of material may be stacked in order to obtain enhanced strength.

4. A portable runway according to claim 1 wherein the target terrain is leveled using suitable earth moving equipment and subsequently, the runway surface is deployed and anchored so that deployment can be done either manually or using mechanized deployment equipment.

5. A portable runway according to claim 1 wherein said portable runway, once usage has been completed, can be refolded by reheating it, collapsing it and collecting it.
